(19) United States
(12) Patent Application Publication
(10) Pub. No.: US 2023/0286860 A1
(43) Pub. Date: Sep. 14, 2023

(54) TREATMENT OF REINFORCEMENTS TO IMPROVE THE INTERFACE TRANSITION ZONE IN CONCRETES

(71) Applicant: The Board of Trustees of The University of Alabama, Tuscaloosa, AL (US)

(72) Inventor: JIALAI WANG, Tuscaloosa, AL (US)

(21) Appl. No.: 18/116,448

(22) Filed: Mar. 2, 2023

Related U.S. Application Data
(60) Provisional application No. 63/317,655, filed on Mar. 8, 2022.

(51) Int. Cl. C04B 20/00; C04B 20/12; C04B 20/10

(52) U.S. Cl. CPC C04B 20/0068; C04B 20/12; C04B 20/1074; C04B 20/1037; C04B 2103/32

(57) ABSTRACT

The present disclosure provides for a concrete including cement binder, aggregate, water, and reinforcement fibers coated with water-soluble amine-containing polymer and at least one layer of nanosilica, and a method of making thereof.

### CROSS REFERENCE TO RELATED APPLICATIONS

This application claims the benefit of priority to U.S. Provisional Application No. 63/317,655, filed Mar. 8, 2022, the disclosure of which is incorporated herein by reference in its entirety.

### BACKGROUND

Concrete is an often-used construction material. It can be considered as a three-phase material: a cement paste matrix, reinforcements, and interfacial transition zones (ITZ) between the cement matrix and reinforcements. The reinforcements can include coarse/fine aggregates, and/or fibers (e.g., steel, polymers, minerals, or natural products). The ITZ can adversely affect the strength and durability of the concrete. This is because the ITZ contains higher porosity and lower cement hydration products compared to other regions. Microcracks can initiate and propagate preferentially in the ITZ, which not only weakens the concrete, but also allows the penetration of deleterious agents through the ITZ.

Engineering the ITZ can enhance both the mechanical performance and long-term durability of the concrete. Coating the reinforcements with a thin layer of nanosilica can improve the ITZ in concretes, as nanosilica can react with calcium hydrate (CH), which is produced by the hydration of cement. As a result, a layer of dense calcium silicate hydrate (C-S-H) can be produced in the ITZ, which densifies the ITZ zone and enhances the bond strength between the reinforcement and the cement matrix. Sol-gel method was used in existing studies to produce nanosilica coating on reinforcements. However, this method requires expensive precursors (e.g., tetraethyl orthosilicate (TEOS)) for silica and surfactant, and a long reaction time, making it economically unfeasible for large scale application in concrete. There is a need for a low-cost, eco-friendly method to treat the surface of concrete reinforcements so that the bond strength between the reinforcements and cement paste matrix can be improved, leading to higher strength and durability of the produced concrete. The compositions and methods disclosed herein address these and other needs.

### SUMMARY

In accordance with the purposes of the disclosed materials and methods, as embodied and broadly described herein, the disclosed subject matter, in one aspect, relates to compositions and methods of making compositions. In specific aspects, the disclosed subject matter relates to concrete and a method of making thereof.

Thus, in one example, a method of making concrete is provided including immersing reinforcement fibers in a solution of water-soluble amine-containing polymer, filtering and drying the reinforcement fibers, immersing the reinforcement fibers in a sodium silicate solution, filtering and drying the reinforcement fibers, and mixing the reinforcement fibers with a cement binder, aggregate, and water.

In a further example, a concrete is provided comprising cement binder, aggregate, water, and reinforcement fibers coated with water-soluble amine-containing polymer and at least one layer of nanosilica.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DESCRIPTION OF THE DRAWINGS

The accompanying figures, which are incorporated in and constitute a part of this specification, illustrate several aspects described below.

FIGS. 1A and 1B show scanning electron microscope (SEM) images of (FIG. 1A) uncoated steel fiber, and (FIG. 1B) coated steel fiber (treated with poly(allylamine hydrochloride) (PAH) and Na₂SiO₃).

FIG. 2 shows the effect of the silica coating on the compressive strength of the concrete.

FIG. 3 shows the effect of silica coating on the flexural strength of the concrete.

FIG. 4 shows the effect of silica coating on the splitting strength of the concrete at 28 days.

FIG. 5 shows the effect of the silica coating on the strain-stress curves of the concrete.

FIG. 6 shows the effect of the silica coating on the pull-out behavior of the steel fiber.

FIG. 7 shows an image of the interface transition zone (ITZ) in concrete.

FIG. 8 shows a schematic of the fibers and phases in concrete.

FIG. 9 shows an exemplary coating process for concrete reinforcements.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### General Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, two or more such compounds, compositions, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range.

### Method

### Method of Making Concrete

The present disclosure provides for a method of making concrete, including immersing reinforcement fibers in a solution of water-soluble amine-containing polymer; filtering and drying the reinforcement fibers; immersing the reinforcement fibers in a sodium silicate solution; filtering and drying the reinforcement fibers; and mixing the reinforcement fibers with a cement binder, aggregate, and water. As used herein, concrete is a material, often used as structural support and/or in construction, that includes cement binder, aggregate, and water. In further embodiments, concrete can include superplasticizer.

As used herein, reinforcement fibers are fibers used to reinforce materials. Reinforcement fibers are often included in materials to improve mechanical properties including, but not limited to, rigidity, crack propagation, and strength. Reinforcement fibers can include natural or synthetic materials and can be used in the manufacture of other materials. In some embodiments, the reinforcement fibers can be discrete. Discrete reinforcement fibers can have a length from 10 mm to 75 mm, or more specifically, from 10 mm to 25 mm, 25 mm to 50 mm, or 50 mm to 75 mm.

As used herein, a solution containing water-soluble amine-containing polymer can be diluted or concentrated. In some embodiments, the solution can have a concentration from 0.1% to 10% by weight of water-soluble amine-containing polymer. In further embodiments, the concentration can be from 0.1% to 2%, 2% to 5%, 5% to 7.5%, or 7.5% to 10% by weight of water-soluble amine-containing polymer. In still other embodiments, the amine-containing polymer can be used neat. In some embodiments, reinforcement fibers can be immersed in the solution from 0.5 hours to 10 hours. In some embodiments, the pH value of the solution can be from 6.0 to 12.

As used herein, water-soluble amine-containing polymers are organic polymers that dissolve, disperse, or swell in water and contain an amine-based polymer. Water-soluble amine-containing polymers can include polyethylene glycol, polyacrylamides, polyacrylic acid copolymer, polyvinyl alcohol, or any combination thereof. In some embodiments, water-soluble amine-containing polymers can include polylysine, polyamines, or any combination thereof. In certain embodiments, polylysine can include poly-L-lysine (PLL), poly-D-lysine (PDL), or any combination thereof. In specific embodiments, polyamine can include poly(allylamine hydrochloride) (PAH) or poly(ethyleneimine).

As used herein, filter means to remove excess and/or unwanted material from a sample. In some embodiments, filtering the reinforcement fibers can include immersing the reinforcement fibers in water.

As used herein, sodium silicate solution means a solution containing sodium silicate. Sodium silicate can include Na₂O₃Si, Na₃O3Si, or Na₂O₂Si. In some embodiments, the sodium silicate solution can have a concentration from 0.01 mol/L to 1.0 mol/L of sodium silicate in solution. In further embodiments, the concentration can be from 0.01 mol/L to 0.20 mol/L, 0.20 mol/L to 0.40 mol/L, 0.40 mol/L to 0.60 mol/L, 0.60 mol/L to 0.80 mol/L, or 0.80 mol/L to 1.0 mol/L of sodium silicate in solution. In some embodiments, reinforcement fibers can be immersed in the sodium silicate solution from 0.5 hours to 10 hours.

As used herein, cement binder is a substance used to bind together the components of concrete. Types of cement binder can include non-hydraulic cement, which does not set in wet conditions or under water, but rather sets as it reacts with carbon dioxide in the air, or hydraulic cement, which sets and becomes adhesive due to a chemical reaction between the dry ingredients and water. In some embodiments, the binder can include Ordinary Portland cement (OPC). In further embodiments, the ratio of water to cement binder can be from 0.20 to 0.60. In certain embodiments, the ratio can be from 0.20 to 0.55, 0.20 to 0.45, 0.20 to 0.35, 0.20 to 0.25, 0.25 to 0.60, 0.25 to 0.50, 0.25 to 0.40, 0.25 to 0.30, 0.30 to 0.60, 0.30 to 0.55, 0.30 to 0.45, 0.30 to 0.35, 0.35 to 0.60, 0.35 to 0.50, 0.35 to 0.40, 0.40 to 0.60, 0.40 to 0.55, 0.40 to 0.55, 0.40 to 0.45, 0.45 to 0.55, 0.50 to 0.60, 0.50 to 0.55, or 0.55 to 0.60.

As used herein, aggregate means an inert granular material that is an ingredient in concrete. Aggregates for concrete are considered based on characteristics that include, but are not limited to, grading, durability, particle shape, surface texture, abrasion, skid resistance, unit weights, voids, absorption, and surface moisture. In certain embodiments, aggregates can include, but are not limited to, sand, gravel, crushed stone, fill, or any combination thereof. In some embodiments, the aggregate can include sand, gravel, crushed stone, or any combination thereof. In further embodiments, the aggregate can comprise sand.

In some embodiments, the reinforcement fibers can include steel, glass, carbon, basalt, polymers, waste plastic, natural fibers, or any combination thereof. In further embodiments, the reinforcement fibers may include copper plated steel.

As used herein, steel is an alloy of iron and carbon. In some embodiments, carbon includes manganese, silicon, phosphorous, sulfur, oxygen, or any combination thereof. Types of steel include carbon steel, tool steel, or stainless steel. Alloy steel can include different metals such as nickel, copper, chromium, cobalt, molybdenum, tungsten, vanadium, aluminum, or any combination thereof. Carbon steel can include low, medium, or high carbon steel. Stainless steel can include austenitic alloys, ferritic alloys, or martensitic alloys.

As used herein, glass means a solid-like and transparent material made from raw materials melted at very high temperatures. At high temperatures, glass can be structurally similar to liquids, while at ambient temperature, it can behave like a solid. Types of glass include annealed glass, heat strengthened glass, tempered or toughened glass, and laminated glass.

As used herein, carbon refers to the carbon atoms bonded together to form reinforcement fibers. In some embodiments, the carbon is in a non-graphitic state. In further embodiments, the carbon atoms are hexagonal carbon atoms. Fibers that include carbon can have a high tensile strength, low density, and high thermal and chemical stabilities. In some embodiments, carbon can include polyacrylonitrile (PAN). Further, embodiments can include rayon or petroleum pitch.

As used herein, basalt refers to the basalt fibers that are used in reinforcement fibers. The basalt fibers are from the basalt rock, which includes the minerals plagioclase, pyroxene, and olivine. In some embodiments, basalt can be extremely fine. Fibers including basalt can be continuous or have discrete lengths.

As used herein, polymer has the same meaning as commonly understood by one of ordinary skill in the art. Types of polymers used in fibers can include nylon, polyester, polypropylene, or any combination thereof. More specifically, polymer can include polyamide nylon, polyethylene terephthalate or polybutylene terephthalate polyester, phenol-formaldehyde, polyvinyl chloride, polyolefin, acrylic, aromatic polyamides, polyethylene, elastomers, polyurethane, elastolefin, or any combination thereof.

As used herein, waste plastic refers to the accumulated plastic objects in the environment. In some embodiments, waste plastic can include single use plastics. Further, waste plastic can include polyethylene terephthalate (PET), high-density polyethylene (HDPE), low-density polyethylene (LDPE), polypropylene (PP), polystyrene (PS), expanded polystyrene (EPS), or any combination thereof. This can include, but is not limited to, plastic from items such as soft drink bottles, milk jugs, shampoo bottles, plastic packaging, shopping bags, furniture, toys, or refrigerator trays.

As used herein, natural fiber means either plant-derived or animal-derived material, including seed hair (e.g., cotton), stem plants (e.g., hemp, flax, bamboo), leaf plants (e.g., sisal and abaca), agricultural fibers (e.g., cereal straw, corn cobs, rice husks, and coconut fibers), lignocellulose fibers (e.g., wood, wood fiber, wood flour, paper, and wood-related materials), or any combination thereof. In some embodiments, the method of making concrete can further include mixing the reinforcement fibers with superplasticizer. As used herein, superplasticizer means an additive used in making concrete, wherein the additive allows for a reduction of water content in the concrete. Superplasticizers can include modified lignosulfonates, sulphonated naphthalene formaldehyde condensates, sulphonated melamine formaldehyde condensates, or polycarboxylate superplasticizers.

In some embodiments, the cement binder, sand, and reinforcement fibers can be mixed in a mixer from 3 to 7 minutes. In further embodiments, the cement binder, sand, and reinforcement fibers can be mixed from 3 to 5 minutes, or 5 to 7 minutes. In some embodiments, water and superplasticizer can be added to a mixer and mixed from 3 to 7 minutes. In further embodiments, water and superplasticizer can be added to a mixer from 3 to 5 minutes, or 5 to 7 minutes.

As used herein, mixer refers to mixers that mix together cement binder, aggregates, and water to form concrete. Mixers may include continuous mixers, which feed ingredients into a drum, mix them, and discharge a concrete slurry simultaneously and continuously until stopped, or batch mixers, which mix and discharge concrete periodically, one batch after another. Batch mixers can include two types of mixers: (1) drum, horizontal, or incline mixers and (2) pan or vertical mixers. Further, drum mixers can include tilting drum mixers, non-tilting drum mixers, and reversing drum mixers. Other types of mixers can include twin shaft concrete mixers, vertical axis concrete mixers, volumetric and metered mixers, and special purpose concrete mixers.

### Composition

### Concrete

The present disclosure provides for concrete that can include cement binder, aggregate, water, and reinforcement fibers coated with water-soluble amine-containing polymer and at least one layer of nanosilica. Concrete, cement binder, aggregate, reinforcement fiber, and water-soluble amine-containing polymer have meanings as described herein.

As used herein, nanosilica refers to nanosized crystalline SiO₂. In some embodiments, nanosilica have a particle size of less than or equal to 100 nm. In further embodiments, nanosilica have a particle size of less than or equal to 50 nm, less than or equal to 30 nm, or less than or equal to 10 nm. In some embodiments, polycondensation of sodium silicate can form the layer of nanosilica. Sodium silicate can include Na₂O₃Si, Na₃O₃Si, or Na₂O₂Si. In some embodiments, the layer of nanosilica can be from 10 nm to 10 μm thick. Specifically, the layer of nanosilica can be from 10 nm to 1μm, 10 nm to 500 nm, 10 nm to 100 nm, 10 nm to 50 nm, 100 to 10 μm, 100 nm to 1μm, 100 nm to 500 nm, or 500 nm to 10 μm thick.

In some embodiments, aggregate can include sand, gravel, crushed stone, or any combination thereof. In further embodiments, aggregate can include sand.

In some embodiments, reinforcement fibers can include steel, glass, carbon, basalt, polymer, waste plastic, natural fibers, or any combination thereof. In further embodiments, reinforcement fibers can include copper plated steel. Steel, glass, carbon, basalt, polymer, waste plastic, and natural fiber have meaning as described herein.

In some embodiments, the concrete can further include mixing the reinforcement fibers with superplasticizer. Superplasticizer has a meaning as described herein.

In some embodiments, the ratio of water to cement binder can be from 0.20 to 0.60. In certain embodiments, the ratio can be from 0.30 to 0.32, 0.32 to 0.34, 0.34 to 0.36, 0.36 to 0.38, or 0.38 to 0.40.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### EXAMPLES

### Example 1: Low-Cost, Environmentally Friendly Treatment for Reinforcements of Concretes

In this example, the reinforcements were treated with a two-step soaking process. In the first step, the concrete reinforcement was soaked into a solution (0.1% -10%) of water-soluble polymer, which can be polylysines (e.g., poly-L-lysine (PLL), poly-D-lysine (PDL)) or polyamines (e.g., poly(allylamine hydrochloride) (PAH), poly(ethyleneimine)), with a pH value of 6.0-12. After soaking for 0.5-10 hours, the reinforcement was filtered out and dried. A thin layer of the polymer was coated on the surface of the reinforcement.

In the next step, the polymer coated reinforcement produced in the first step was soaked in a sodium silicate solution (0.1-1 mol/L). After soaking for 0.5-10 hours, the reinforcement was filtered out and dried for use in concretes. Concrete with the treated reinforcement can be manufactured in the same way as those with untreated reinforcement.

This method had numerous advantages. It doesn't require any expensive chemicals or complex equipment. It is eco-friendly because no toxic precursor material or surfactant is needed, and no hazardous waste is produced. The whole process can be completed within a few hours and can be scaled up. The improvement in bond strength between the reinforcement and the cement matrix induced by this treatment exceeds that achieved by existing methods.

### Materials

The steel fiber was the copper plated fiber with 0.2 mm±0.02 mm diameter and 14 mm±1 mm length. PAH and Na₂SiO₃ were the analytical purity. The PBS buffer with 7.0-7.2 pH value was used to provide a stable pH aqueous solution environment. The Ordinary Portland (OPC) cement was used as the binder in the concrete specimen. The river sand was used as the fine aggregate in concrete. The superplasticizer was used to increase the workability of fresh concrete.

### Methodology

The 0.6 g PAH was added to 1 L of PBS buffer and mixed for 2 minutes. The 0.33 kg steel fiber was soaked in the prepared PAH solution for 3 hours. The steel fiber was then immersed in fresh water to remove the ion residue. The free moisture on the steel fiber was removed by a towel. After this, the steel fiber was soaked in 1 L of 0.1 mol/L Na₂SiO₃ solution for 3 hours. The steel fiber was immersed in fresh water to remove the ion residue. The treated steel fiber was then dried in a drier at 45° C. for 6 hours until reaching a constant weight.

The mix proportion of concrete is shown in Table 1. The water to binder ratio was 0.35. The OPC, sand, and steel fibers were mixed in the mixer for 3 minutes. Then fresh water and superplasticizer were added to the mixer and mixed for another 3 minutes. The fresh concrete was cast into 50 mm cubic molds, 40 mm×40 mm×160 mm cuboid molds and 37 mm diameter and 74 mm height cylinder molds. After 24 hours, the hardened concrete was demolded and cured in a curing room with a temperature of 23° C. and a relative humidity (RH)≥95%. The cylindrical specimens were used to measure the compressive strength of concrete, and the cubic specimens were used to evaluate the flexural strength of concrete. The cylinder specimens were used to test the static and dynamic splitting tensile strength.

Scanning electron microscopy was used to examine the surface of the steel fiber. The bonding behavior between the steel fiber and cement matrix was examined by a single fiber pull-out test.

TABLE 1
Mix proportion (kg/m³)

| Materials | Water | OPC | Sand | Steel fiber | Superplasticizer |
|---|---|---|---|---|---|
| Control | 230 | 657 | 1313 | 0 | 3.7 |
| 1% | 230 | 657 | 1313 | 105 | 5 |
| 2% | 230 | 657 | 1313 | 210 | 5 |
| 3% | 230 | 657 | 1313 | 315 | 5 |

### Results

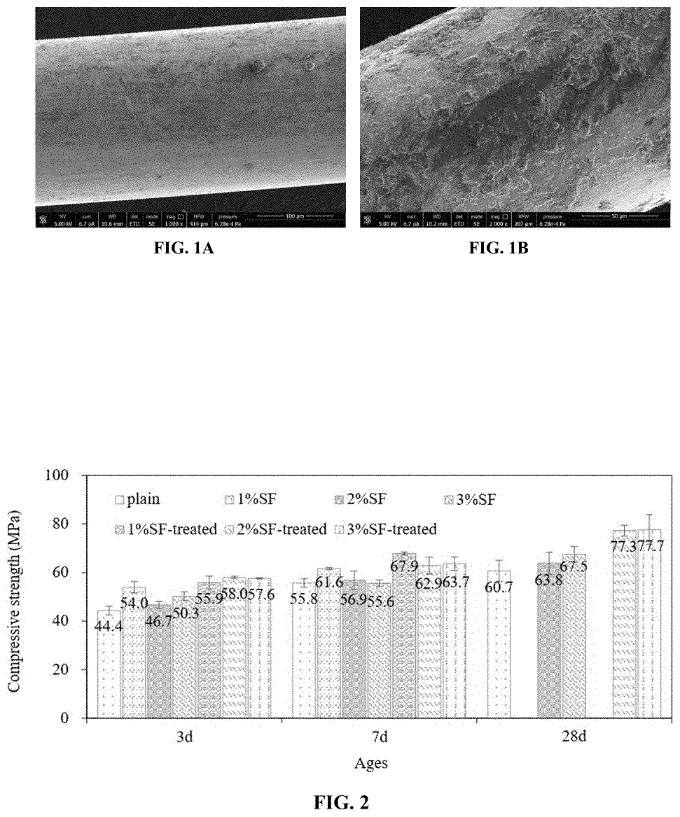

FIGS. 1A and 1B compare the scanning electron microscope (SEM) images of the virgin steel fiber and the silica coated fibers. It can be seen that a layer of nanosilica was deposited on the steel fiber by the proposed method.

FIG. 2 shows that the proposed treatment enhanced the compressive strength of the concrete. For example, over 20% improvement on the compressive strength at 28 days was achieved by treating 2% steel fibers with the proposed method.

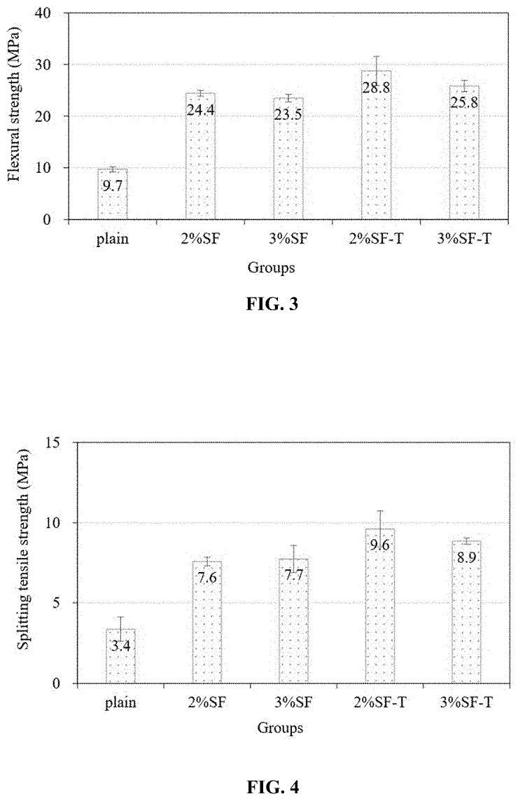

FIG. 3 shows that the proposed treatment method increased the flexural strength as well. Similarly, the splitting tensile strength was improved by more than 26% by the proposed treatment.

FIG. 5 shows the effect of the proposed treatment on the strain-stress behavior of concrete. It can be seen that ductility of the concrete was substantially improved by the proposed method.

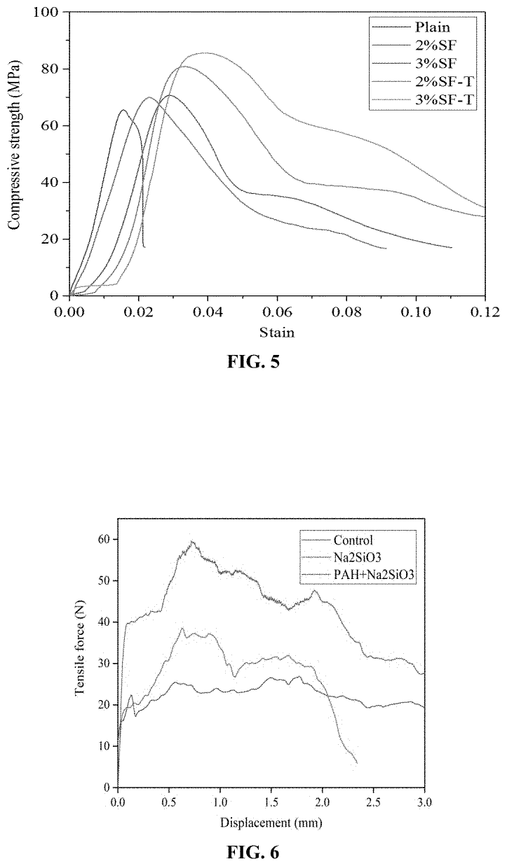

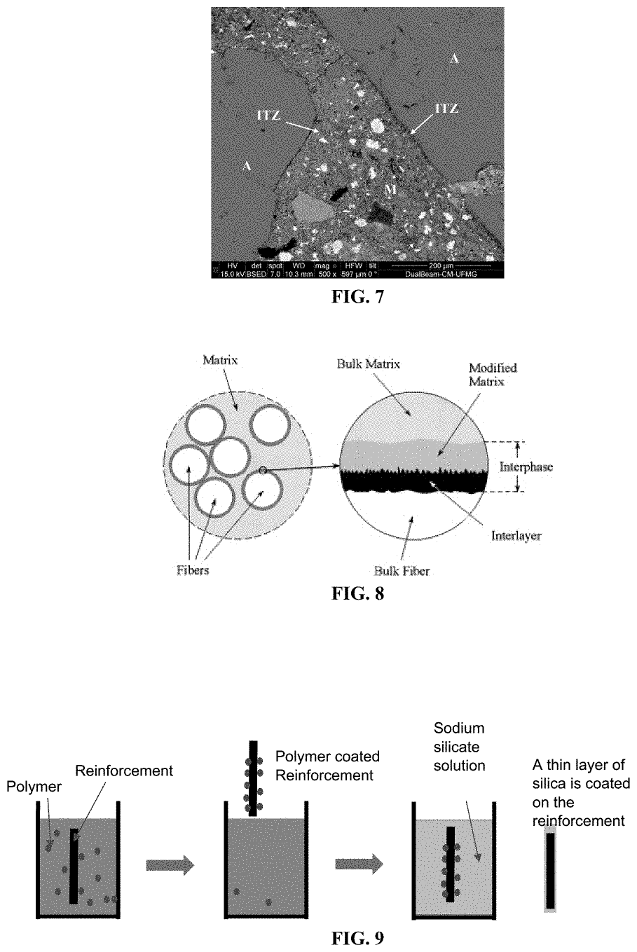

FIG. 6 compares the pull-out behaviors of the virgin fiber, the fiber coated with only sodium silicate, and the fiber coated by the proposed treatment. Drastic improvement on the bond strength and ductility between the steel fibers and the cement matrix was achieved by the proposed method. Very little improvement was achieved by treating the steel fiber with only sodium silicate, confirming the benefits of the proposed treatment method.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A method of making concrete, comprising immersing reinforcement fibers in a solution of water-soluble amine-containing polymer; filtering and drying the reinforcement fibers; immersing the reinforcement fibers in a sodium silicate solution; filtering and drying the reinforcement fibers; and mixing the reinforcement fibers with a cement binder, aggregate, and water.

2. The method of claim 1, wherein the reinforcement fibers comprise steel, glass, carbon, basalt, polymers, waste plastic, natural fibers, or any combination thereof.

3. The method of claim 1, wherein the solution has a concentration of from 0.1% to 10% by weight of water-soluble amine-containing polymer.

4. The method of claim 1, wherein the water-soluble amine-containing polymer comprises polylysine, polyamine, or any combination thereof

5. The method of claim 4, wherein polylysine comprises poly-L-lysine, poly-D-lysine, or any combination thereof.

6. The method of claim 4, wherein polyamine comprises poly(allylamine hydrochloride) or poly(ethyleneimine).

7. The method of claim 1, wherein the pH value of the solution is from 6.0 to 12.

8. The method of claim 1, wherein the reinforcement fibers are immersed in the sodium silicate solution from 0.5 hours to 10 hours.

9. The method of claim 1, wherein the sodium silicate solution has a concentration from 0.01 mol/L to 1.0 mol/L of sodium silicate in solution.

10. The method of any one of claim 1, wherein filtering the reinforcement fibers comprises immersing the reinforcement fibers in water.

11. The method of any one of claim 1, wherein the aggregate comprises sand, gravel, crushed stone, or any combination thereof.

12. The method of any one of claim 1, further comprising mixing the reinforcement fibers with superplasticizer.

13. The method of any one of claim 1, wherein the ratio of water to cement binder is from 0.20 to 0.60.

14. A concrete comprising cement binder, aggregate, water, and reinforcement fibers coated with water-soluble amine-containing polymer and at least one layer of nanosilica.

15. The concrete of claim 14, wherein the aggregate comprises sand, gravel, crushed stone, or any combination thereof.

16. The concrete of claim 14, wherein the reinforcement fibers comprise steel, glass, carbon, basalt, polymer, waste plastic, natural fibers, or any combination thereof

17. The concrete of claim 14, further comprising a superplasticizer.

18. The concrete of claim 14, wherein the ratio of water to cement binder is from 0.20 to 0.60.

19. The concrete of claim 14, wherein the layer of nanosilica is from 10 nm to 10 thick.

20. The concrete of claim 14, wherein polycondensation of sodium silicate forms the layer of nanosilica.
